(19) United States
(12) Patent Application Publication
(10) Pub. No.: US 2024/0253067 A1
(43) Pub. Date: Aug. 1, 2024

(54) MULTI SPRAY PATTERN SHOWERHEAD FOR STIMULATING FEMALE GENITALIA

(71) Applicant: Christine MacDougall, Inverness (CA)

(72) Inventor: Christine MacDougall, Inverness (CA)

(21) Appl. No.: 18/426,662

(22) Filed: Jan. 30, 2024

(30) Foreign Application Priority Data
Jan. 30, 2023 (CA) 3188062

(51) Int. Cl. B05B 1/18; A61H 19/00

(52) U.S. Cl. CPC B05B 1/18; A61H 19/30

(57) ABSTRACT

A multi spray pattern showerhead assembly is provided. The multi spray pattern showerhead assembly comprises a housing having an inlet port at a first end thereof. The inlet port is adapted for mounting to a water source connection. An outlet assembly is mounted to a second end of the housing. The outlet assembly comprises a plurality of nozzles. A distributor assembly is connected to the outlet assembly. The distributor assembly is adapted for receiving a water flow from the inlet port and for selectively providing the water flow to at least one subset of the plurality of nozzles. A control circuit is connected to the distributor assembly. The control circuit being adapted for controlling the distributor assembly such that the distributor assembly provides the water flow selectively to a series of different subsets of the plurality of nozzles.

### BACKGROUND OF THE INVENTION

### 1. Field of the Invention

The present invention relates to showerheads, and more particularly to a multi spray pattern showerhead for stimulating female genitalia.

### 2. Brief Description of the Related Art

A wide variety of showerheads are known in the art for residential use. Multi spray pattern showerheads provide a plurality of spray patterns, including various standard sprays and pulsed sprays. However, these showerheads have in common the requirement of manual actuation for selecting a spray pattern. Typically, the spray pattern is selected by using a control ring positioned around the circumference of the showerhead, and movable with respect to the showerhead. The control ring is rotated around the showerhead to select the desired spray pattern. As a result, only a single spray pattern is experienced before a manual adjustment is required to experience another spray pattern. The requirement of manual user interaction to modify the spray pattern results in a substantially reduced enjoyment of the shower experience.

It is known that a water spray interacting with genitalia and, in particular, with female genitalia can result in a pleasurable experience which can be enhanced by using different spray pattern. Unfortunately, this pleasurable experience is substantially reduced or even terminated when interrupted by the requirement of manually adjusting the showerhead to experience another spray pattern.

It is desirable to provide a multi spray pattern showerhead for stimulating female genitalia.

It is also desirable to provide a multi spray pattern showerhead for stimulating female genitalia that provides multiple spray patterns absent manual adjustment of the showerhead.

It is also desirable to provide a multi spray pattern showerhead for stimulating female genitalia that enables a user to determine a series of multiple spray patterns.

It is also desirable to provide a multi spray pattern showerhead for stimulating female genitalia that enables a user to select a series from a plurality of series of multiple spray patterns.

### SUMMARY OF THE INVENTION

Accordingly, one object of the present invention is to provide a multi spray pattern showerhead for stimulating female genitalia.

Another object of the present invention is to provide a multi spray pattern showerhead for stimulating female genitalia that provides multiple spray patterns absent manual adjustment of the showerhead.

Another object of the present invention is to provide a multi spray pattern showerhead for stimulating female genitalia that enables a user to determine a series of multiple spray patterns.

Another object of the present invention is to provide a multi spray pattern showerhead for stimulating female genitalia that enables a user to select a series from a plurality of series of multiple spray patterns.

According to one aspect of the present invention, there is provided a multi spray pattern showerhead assembly. The multi spray pattern showerhead assembly comprises a housing having an inlet port at a first end thereof. The inlet port is adapted for mounting to a water source connection. An outlet assembly is mounted to a second end of the housing. The outlet assembly comprises a plurality of nozzles. A distributor assembly is connected to the outlet assembly. The distributor assembly is adapted for receiving a water flow from the inlet port and for selectively providing the water flow to at least one subset of the plurality of nozzles. A control circuit is connected to the distributor assembly. The control circuit being adapted for controlling the distributor assembly such that the distributor assembly provides the water flow selectively to a series of different subsets of the plurality of nozzles.

According to the aspect of the present invention, there is provided a multi spray pattern showerhead assembly. The multi spray pattern showerhead assembly comprises a housing having an inlet port at a first end thereof. The inlet port is adapted for mounting to a water source connection. An outlet assembly is mounted to a second end of the housing. The outlet assembly comprises a plurality of nozzles. A distributor assembly is connected to the outlet assembly. The distributor assembly is adapted for receiving a water flow from the inlet port and for selectively providing the water flow to at least one subset of the plurality of nozzles. A control circuit is connected to the distributor assembly. The control circuit being adapted for controlling the distributor assembly such that the distributor assembly provides the water flow selectively to a series of different subsets of the plurality of nozzles. The distributor assembly comprises at least an electromechanical component for selectively providing the water flow. The control circuit comprises a processor adapted for executing executable commands stored in non-volatile memory. The processor when executing the executable commands provides control signals to the control circuit such that the distributor assembly provides the water flow selectively to a series of different subsets of the plurality of nozzles.

According to the aspect of the present invention, there is provided a multi spray pattern showerhead assembly. The multi spray pattern showerhead assembly comprises a housing having an inlet port at a first end thereof. The inlet port is adapted for mounting to a water source connection. An outlet assembly is mounted to a second end of the housing. The outlet assembly comprises a plurality of nozzles. A distributor assembly is connected to the outlet assembly. The distributor assembly is adapted for receiving a water flow from the inlet port and for selectively providing the water flow to at least one subset of the plurality of nozzles. A control circuit is connected to the distributor assembly. The control circuit being adapted for controlling the distributor assembly such that the distributor assembly provides the water flow selectively to a series of different subsets of the plurality of nozzles. The plurality of nozzles is arranged in an array having a predetermined number of rows and columns and each row and each column is associated with a subset of nozzles. At least one nozzle in close proximity to a centre of the array is associated with another subset.

According to the aspect of the present invention, there is provided a method of providing multi spray patterns. A water flow is received at an inlet port. A control circuit provides control signals to a distributor assembly. The distributor assembly provides the water flow selectively to a series of different subsets of the plurality of nozzles with each being associated with a respective spray patten. The plurality of nozzles is arranged in an array having a predetermined number of rows and columns and each row and each column is associated with a subset of nozzles and at least one nozzle in close proximity to a centre of the array is associated with another subset. The distributor assembly provides the water flow selectively to a series of rows. The distributor assembly provides the water flow selectively to a series of columns. The distributor assembly providing the water flow selectively to the at least one nozzle in close proximity to a centre of the array.

The advantage of the present invention is that it provides a multi spray pattern showerhead for stimulating female genitalia.

A further advantage of the present invention is that it provides a multi spray pattern showerhead for stimulating female genitalia that provides multiple spray patterns absent manual adjustment of the showerhead.

A further advantage of the present invention is that it provides a multi spray pattern showerhead for stimulating female genitalia that enables a user to determine a series of multiple spray patterns.

A further advantage of the present invention is that it provides a multi spray pattern showerhead for stimulating female genitalia that enables a user to select a series from a plurality of series of multiple spray patterns.

### BRIEF DESCRIPTION OF THE DRAWINGS

A preferred embodiment of the present invention is described below with reference to the accompanying drawings, in which:

FIG. 1 is a simplified block diagram illustrating in a side view a multi spray pattern showerhead assembly according to a preferred embodiment of the invention;

FIG. 2 is a simplified block diagram illustrating in a bottom view an array of nozzles of the multi spray pattern showerhead assembly according to the preferred embodiment of the invention;

FIG. 3 is a simplified block diagram illustrating in a cross-sectional view a distributor assembly of the multi spray pattern showerhead assembly according to the preferred embodiment of the invention;

FIG. 4 is a simplified block diagram illustrating in a top view a distributor block of the multi spray pattern showerhead assembly according to the preferred embodiment of the invention;

FIGS. 5A to 5C are simplified block diagrams illustrating in a cross-sectional view, a top view, and a bottom view, respectively, a distributor element of the multi spray pattern showerhead assembly according to the preferred embodiment of the invention;

FIG. 6 is a simplified block diagram illustrating a control circuit of the multi spray pattern showerhead assembly according to the preferred embodiment of the invention; and

FIGS. 7 and 8 are simplified block diagrams illustrating in bottom views different arrays of nozzles of the multi spray pattern showerhead assembly according to the preferred embodiment of the invention.

### DETAILED DESCRIPTION OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to a fixed mount multi spray pattern showerhead assembly for stimulating female genitalia, it will become evident to those skilled in the art that the embodiments of the invention are not limited thereto, but may also be implemented as a handheld multi spray pattern showerhead assembly and adapted for providing other shower experiences such as, for example, massaging type shower experiences.

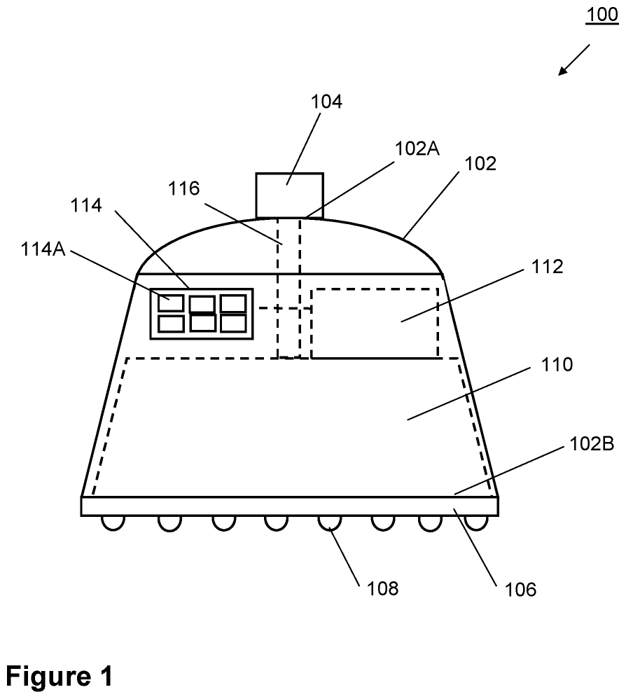

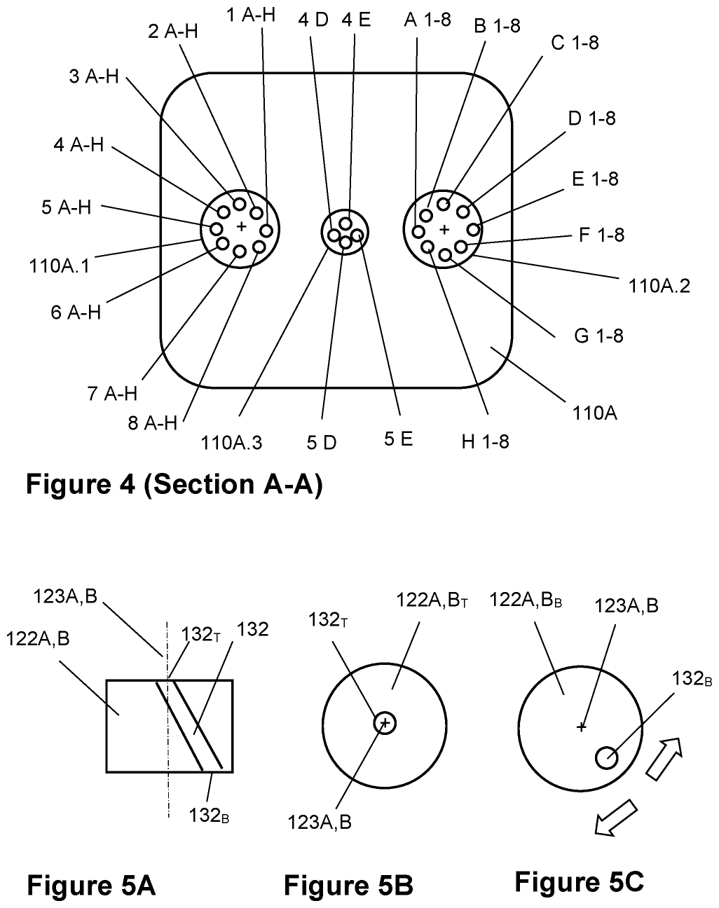

Referring to FIGS. 1 to 8 a multi spray pattern showerhead assembly 100 for stimulating female genitalia according to a preferred embodiment of the invention is provided. The multi spray pattern showerhead assembly 100 comprises housing 102 having an inlet port 104 at a first end 102A thereof. The inlet port 104 is adapted for mounting to a water source connection such as, for example, a shower arm. Outlet assembly 106 is mounted to a second end 102B of the housing 102. The outlet assembly comprises a plurality of nozzles 108. Distributor assembly 110 is connected to the outlet assembly 106. The distributor assembly 110 receives a water flow from the inlet port 104 via inlet conduit 116 connected thereto and selectively provides the water flow to at least one subset of the plurality of nozzles 108, as will be described hereinbelow. Control circuit 112 is connected to electromechanical components of the distributor assembly 110. The control circuit 112 controls the distributor assembly 112 such that the distributor assembly 112 provides the water flow selectively to a series of different subsets of the plurality of nozzles 108. Optionally, a waterproof user interface 114 comprising, for example, waterproof push buttons 114A, is disposed in the housing 102 and connected to the control circuit 112.

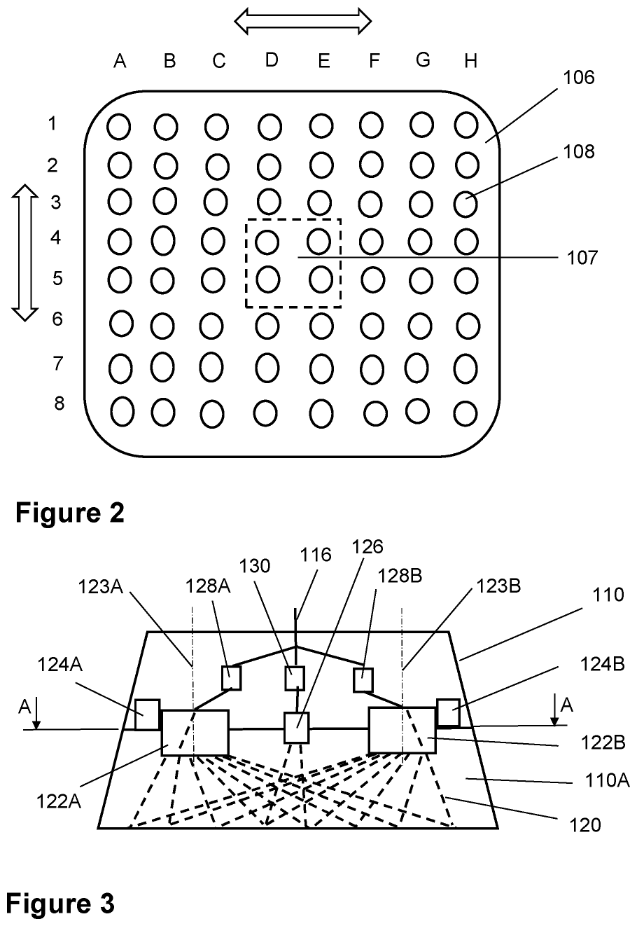

Preferably, the plurality of nozzles 108 is arranged in an array having a predetermined number of rows and columns such as, for example, rows 1-8 and columns A-H, as illustrated in FIG. 2. Each row and each column is associated with a subset of the plurality of nozzles 108 for creating a respective spray pattern. Further preferably, four nozzles 108 in close proximity to centre 107 of the array is associated with another subset, as indicated by the dashed box in FIG. 2.

In a preferred operation of the multi spray pattern showerhead assembly 100 the water flow is provided to:
a series of successive rows 1-8, for example from row 1 to row 8 and/or row 8 to row 1, as indicated by the block arrow in FIG. 2;
a series of successive columns A-H, for example from column A to column H and/or column H to column A, as indicated by the block arrow in FIG. 2; and, the four nozzles in close proximity to the centre 107 of the array, i.e. at array locations 4D, 4E, 5D, and 5E.

This operation allows the realization of numerous different series of spray patterns. For example, first provide water flow from series of successive rows—1-8, 1-8, 1-8, . . . or 1-8, 8-1, 1-8, . . . —followed by water flow from series of successive columns—A-H, A-H, A-H, . . . or A-H, H-A, A-H, . . . —followed by strong water flow from the four nozzles 4D, 4E, 5D, and 5E. Optionally, a pulsating water flow may be provided.

As is evident to one skilled in the art, numerous other series of spray patterns may be realized. For example, a series of successive rows is followed by a series of successive columns which is then followed by a series of successive rows, etc., or a series of odd numbered rows is followed by a series of even numbered rows, or a row is followed by a column—row 1, column A, row 2, column B, etc.

Referring to FIGS. 3, 4, 5A, 5B, and 5C, the distributor assembly 110, preferably, comprises distributor block 110A having a plurality of conduits 102 disposed therein. The bottom end of the conduits 120 is adapted to provide the water flow to a respective nozzle 108 with the bottom end of the distributor block 110A being in contact with the outlet assembly 106. The conduits 120 are disposed such that each nozzle 108 of the array is connected to recessed first distributor interface 110A.1 such that nozzles associated with a specific row are connected to a respective distributor opening:
row 1 connected to distributor opening 1 A-H;
row 2 connected to distributor opening 2 A-H;
row 3 connected to distributor opening 3 A-H;
row 4 connected to distributor opening 4 A-H;
row 5 connected to distributor opening 5 A-H;
row 6 connected to distributor opening 6 A-H;
row 7 connected to distributor opening 7 A-H; and,
row 8 connected to distributor opening 8 A-H.
The distributor openings 1 A-H to 8 A-H are arranged in a concentric circle around the centre of the circular first distributor interface 110A.1.

Similarly, the conduits 120 are disposed such that each nozzle 108 of the array is connected to a recessed second distributor interface 110A.2 such that nozzles associated with a specific column are connected to a respective distributor opening:
column A connected to distributor opening A 1-8;
column B connected to distributor opening B 1-8;
column C connected to distributor opening C 1-8;
column D connected to distributor opening D 1-8;
column E connected to distributor opening E 1-8;
column F connected to distributor opening F 1-8;
column G connected to distributor opening G 1-8; and,
column H connected to distributor opening H 1-8.
The distributor openings A 1-8 to H 1-8 are arranged in a concentric circle around the centre of the circular second distributor interface 110A.2.

Further, the conduits 120 are disposed such that the four nozzles in close proximity to the centre 107 of the array-4D, 4E, 5D, and 5E-are connected to recessed third distributor interface 110A.3.

The distributor block 110A is made of, for example, a conventional plastic material using conventional plastic moulding technology or 3D printing technology.

Cylindrical distributor elements 122A and 122B are rotatable movable about respective axis 123A and 123B disposed in the respective cavity associated with the respective recessed first distributor interface 110A.1 and the respective recessed second distributor interface 110A.2. Each distributor element 122A, 122B has conduit 132 disposed therein with the top end 132T being placed at the center and the bottom end 132B being placed a predetermined distance from the centre such that the bottom end 132B coincides with the concentric circle of the distributor openings of the respective distributor interface 110A.1, 110A.2. By rotating the distributor elements 122A and 122B with respect to the distributor interfaces clockwise or counter-clockwise, as indicated by the block arrows in FIG. 5C, water received at the top end 132T is provided via the bottom end 132B successively to the different distributor openings of the distributor interfaces which, in turn, provide the water flow to the respective rows or columns of nozzles associated therewith. Preferably, the distributor elements 122A and 122B are rotated using electromechanical actuators 124A and 124B such as, for example, commercially available miniature stepper motors.

Preferably, water flow received from the inlet conduit 116 is controllably provided to the distributor elements 122A and 122B via electromechanical valves 128A and 128B, respectively. By opening valve 128A water flow is provided to distributor element 122A for providing the water flow to successive rows of nozzles 108. Alternatively, by opening valve 128B water flow is provided to distributor element 122B for providing the water flow to successive columns of nozzles 108. Electromechanical valve 130 is connected to distributor element 126 in fluid communication with the distributor interface 110A.3. The electromechanical valve 130 controllably provides the water flow to the four nozzles in close proximity to the centre 107 of the array at locations 4D, 4E, 5D, and 5E. A pulsating water flow can be created, for example, by operating the valves 128A, 128B, and 130 in a pulsating manner. The valves 128A, 128B, and 130 are, for example, commercially available miniature electromechanical valves.

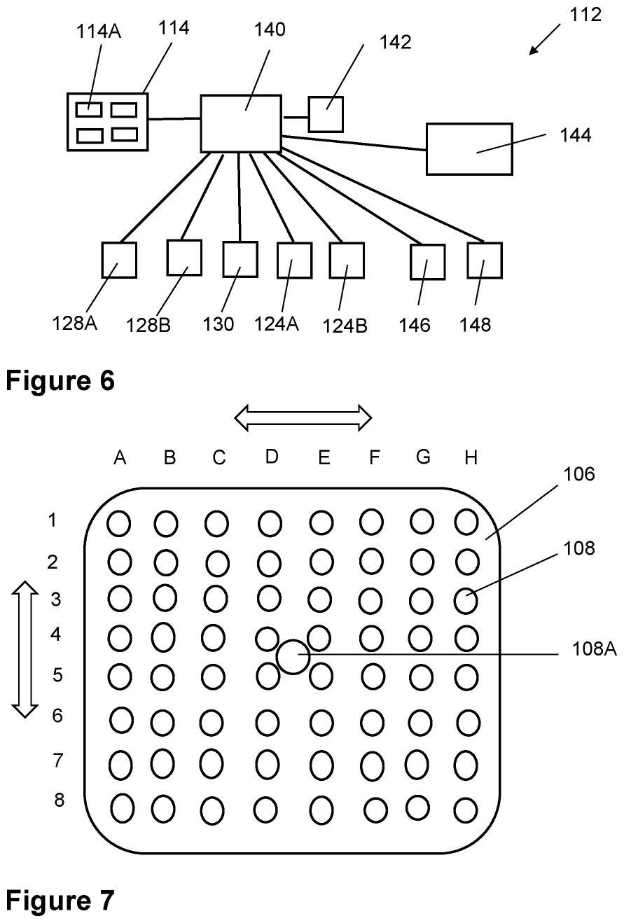

Preferably, the control circuit 112 comprises processor 140 adapted for executing executable commands stored in non-volatile memory 142, as illustrated in FIG. 6. The processor 140 is connected to the valves 128A, 128B, and 130 and the electromechanical actuators 124A and 124B. When executing the executable commands the processor 140 provides control signals to the valves 128A, 128B, and 130 and the electromechanical actuators 124A and 124B such that the water flow is selectively provided to a series of different subsets of the plurality of nozzles 108, as described hereinabove. As processor 140, a commercially available microprocessor may be employed. The processor 140 is powered via electrical power source 144 such as a battery which is disposed in the housing 102 and may be removed and replaced via a waterproof access.

Optionally, the processor 140 is connected to waterproof user interface 114 disposed in the housing 102. The user interface 114 comprises, for example, waterproof push buttons 114A to enable a user to determine one or more series of different subsets of the plurality of nozzles 108 associated with different spray patterns. Further optionally, the user may be enabled to, in addition to determine the series of different subsets, determine the duration of each spray pattern, as well as the strength of the water flow, for example, a gentle water flow, a strong water flow, or a strength therebetween. Alternatively, the user interface 114 may be provided as a remote device in wireless communication with the processor 140 using for example, Bluetooth technology.

Further optionally the processor 140 may be connected to pressure sensor 146 disposed in the inlet conduit 116. For example, when the water pressure sensed by the pressure sensor 146 is indicative of the water supply being turned off, the processor 140 shuts down operation to save battery power when the showerhead is not in use.

Further optionally the processor 140 may be connected to temperature sensor 148 disposed in the inlet conduit 116. For example, when the water temperature sensed by the temperature sensor 148 is above a predetermined threshold, the processor 140 provides control signals to the valves 128A, 128B, and 130 to shut off the water flow to prevent exposure of the user to water that is too hot.

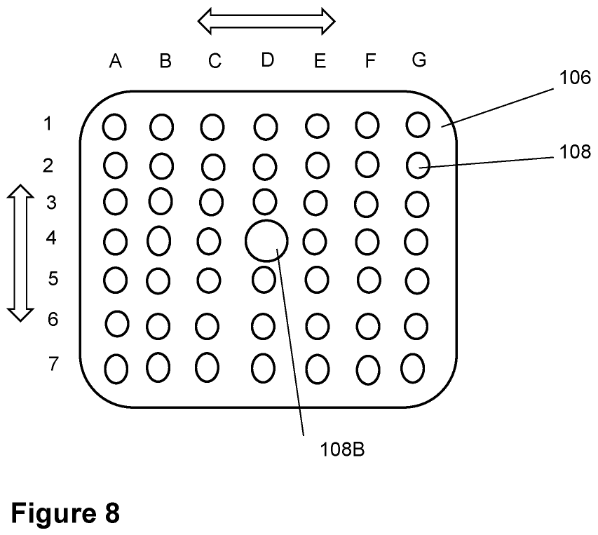

Similar spray patterns to the ones realized with array of nozzles 108 illustrated in FIG. 2 can be realized using the arrays of nozzles illustrated in FIGS. 7 and 8. In the array of nozzles 108 illustrated in FIG. 7 an additional larger nozzle 108A is placed at the centre of the array between the four nozzles located at 4D, 4E, 5D, and 5E for providing the strong water flow or water jet instead of the four nozzles located at 4D, 4E, 5D, and 5E. In the array of nozzles 108 illustrated in FIG. 8 an odd number of rows and columns is provided with a large nozzle 108B placed at the centre of the array for providing the strong water flow or water jet.

As is evident to one skilled in the art, the multi spray pattern showerhead assembly 100 may be adapted to provide numerous other series of spray patterns depending on design preferences such as for, for example, arrangement of the nozzles 108 in concentric circles with the nozzles of each circle being activated successively from the centre outward or vice versa.

The present invention has been described herein with regard to preferred embodiments. However, it will be obvious to persons skilled in the art that a number of variations and modifications can be made without departing from the scope of the invention as described herein.

What is claimed is:

1. A multi spray pattern showerhead assembly comprising:
a housing having an inlet port at a first end thereof, the inlet port being adapted for mounting to a water source connection;
an outlet assembly mounted to a second end of the housing, the outlet assembly comprising a plurality of nozzles;
a distributor assembly connected to the outlet assembly, the distributor assembly being adapted for receiving a water flow from the inlet port and for selectively providing the water flow to at least one subset of the plurality of nozzles; and,
a control circuit connected to the distributor assembly, the control circuit being adapted for controlling the distributor assembly such that the distributor assembly provides the water flow selectively to a series of different subsets of the plurality of nozzles.

2. The showerhead assembly according to claim 1 wherein the distributor assembly comprises at least an electromechanical component for selectively providing the water flow.

3. The showerhead assembly according to claim 2 wherein the distributor assembly comprises a pulsator for creating a pulsating water flow.

4. The showerhead assembly according to claim 3 wherein the control circuit comprises a processor adapted for executing executable commands stored in non-volatile memory, the processor when executing the executable commands providing control signals to the control circuit such that the distributor assembly provides the water flow selectively to a series of different subsets of the plurality of nozzles.

5. The showerhead assembly according to claim 4 wherein the control circuit comprises a waterproof user interface.

6. The showerhead assembly according to claim 1 wherein the plurality of nozzles is arranged in an array having a predetermined number of rows and columns and wherein each row and each column is associated with a subset of nozzles.

7. The showerhead assembly according to claim 6 wherein at least one nozzle in close proximity to a centre of the array is associated with another subset.

8. A method of providing multi spray patterns using the showerhead assembly according to claim 1, comprising:
receiving the water flow at the inlet port;
the control circuit providing control signals to the distributor assembly; and, the distributor assembly providing the water flow selectively to a series of different subsets of the plurality of nozzles with each being associated with a respective spray patten.

9. The method according to claim 8 comprising pulsating the water flow.

10. The method according to claim 9 comprising:
the control circuit receiving user input data, the user input data being indicative of a user determined series of different subsets of the plurality of nozzles;
the control circuit providing control signals to the distributor assembly in dependence upon the user input data.

11. The method according to claim 8 wherein the plurality of nozzles is arranged in an array having a predetermined number of rows and columns and wherein each row and each column is associated with a subset of nozzles and wherein at least one nozzle in close proximity to a centre of the array is associated with another subset, comprising:
the distributor assembly providing the water flow selectively to a series of rows;
the distributor assembly providing the water flow selectively to a series of columns; and, the distributor assembly providing the water flow selectively to the at least one nozzle in close proximity to a centre of the array.

12. The method according to claim 11 comprising:
the distributor assembly providing a pulsating water flow.

13. The method according to claim 12 wherein distributor assembly provides the water flow to a series of successive rows.

14. The method according to claim 13 wherein distributor assembly provides the water flow to a series of successive columns.
